(19) United States
(12) Patent Application Publication
(10) Pub. No.: US 2009/0107407 A1
(43) Pub. Date: Apr. 30, 2009

(54) Water-feeding device for domestic animals

(76) Inventor: Shu-Han Lee, Shin-Chuang (TW)

Correspondence Address: Meng-Tsuey Pan, P. O. Box 1-252, Sanchung, TW

(21) Appl. No.: 11/978,012

(22) Filed: Oct. 29, 2007

(51) Int. Cl. A01K 7/00

(52) U.S. Cl. 119/72

(57) ABSTRACT

A water-feeding device of the present invention includes a main body, a vertically weighted lever, a steel ball, a moving lever and a valve. The main body is a segment of a thin stainless steel metal cylinder as material. An upper half of the cylinder is narrowed to a cylinder with a smaller diameter, and the upper end of the cylinder is opened with a narrowed opening. A male thread is provided on the sidewall of the cylinder with the narrowed diameter. The vertically weighted lever, steel ball, moving lever and valve are inserted from the bottom to top such that the valve is affixed at an edge between the cylinder with the narrowed diameter and the cylinder with a bigger diameter on the lower portion thereof. The cylinder with the bigger diameter is narrowed into a small opening at lower end and formed with a sidewall of a hexagon.

### FIELD OF THE INVENTION

The present invention relates to a water-feeding device for domestic animals; more particularly, a water-feeding device having a main body that is easy in manufacturing with low material cost, while the main body is easily manufactured and the efficient manufacturing steps as well as the improved structure thereof.

### BACKGROUND OF THE INVENTION

The conventional water-feeding device used for feeding chickens in a chicken farm has a main body 100, a plug lever 200 and a vertically weighted lever 300, as shown in FIGS. 5 and 6. The plug lever 200 and the vertically weighted lever 300 are inserted in sequence to a level hole 104 in the main body 100, as shown in FIG. 6 such that the conventional water-feeding device for domestic animals, especially for chickens, can be quickly assembled, as shown in FIG. 5. From its appearance, it can be known that the structure of the conventional water-feeding device for domestic animals, especially for chickens, is very simple and can be easily and efficiently assembled. However, because the three components are all made of stainless steel material, the plug lever 200 and the vertically weighted lever 300 have smaller diameters with lighter weight, and the structures thereof are also not complex, it can be manufactured with an automatic lathe. Thus, the manufacturing material and cost are not expensive and are still acceptable. However, the diameter of the main body 100 is quite big, and is made of solid lever, as shown in FIG. 6, such that it is quite heavy in weight, increasing the manufacturing material and cost. During the manufacturing process, a segment of a solid stainless steel lever 101 is first obtained. Then, an upper end is provided with male thread 102 and a segment 103 with a smaller diameter. A through hole is then provided in the middle of the lever 101 such that a level hole 104 is provided thereon. A trumpet-shaped hole 105 is further provided beneath the small diameter of the level hole 104. A lower end of the lever 101 is provided with a slope 106. Finally, it is moved to a milling machine so as to provide a pair of parallel sides 107, 108 on the slope 106 for clamping a wrench used for assembly or disassembly. The manufacturing process is then complete. The above-mentioned components are then ready for assembly to form a water-feeding device for domestic animals, especially for chickens. It is time consuming and consequently results in higher material and manufacturing costs.

Furthermore, the conventional water-feeding device for domestic animals, especially for pigs, used in a pig farm includes a main body 100a, a moving lever 200, a steel ball 400 and a screw plug 500, as shown in FIG. 7. The moving lever 200 and the steal ball 400 are pivotally inserted into a level hole 104 of the main body 100a in sequence. Then, the upper end thereof is screwed with the screw plug 500 so as to form a water-feeding device for domestic animals, especially for pigs. The structure of the water-feeding device for feeding pigs is the same as that for feeding chickens, except that the steel ball 400 replaces the plug lever 300 for closing purpose, and that a screw plug 500 is installed at the upper end of the main body 100a. The manufacturing steps of the main body 100a are also the same as those of the water-feeding device for feeding chickens. First, by obtaining a segment of solid stainless steel lever 101a, and then a male thread 102 is provided on an upper end thereof. A through hole is then provided in the center of the lever 101a followed by providing a level hole 104. Then, a section of female thread 109 is provided at the lever hole 104 with the big diameter so as to screw a screw plug 500. Afterwards, a slope 106 is provided at a lower end of the lever 101a. Finally, it is moved to a milling machine, and a pair of parallel sides 107, 108 is provided on the slope 106 so as to allow a wrench to be clamped for assembly or disassembly. The manufacturing steps are thus complete so as to allow the water-feeding device for domestic animals, especially for pigs, to be assembled. Since the main body 100a of the water-feeding device for feeding pigs is at least twice as big as that for the main body 100 of the water-feeding device for feeding chickens, the manufacturing steps are very similar, and the solid lever of the main body 100a has bigger diameter and is heavier in weight, the manufacturing cost and material cost are very expensive.

### SUMMARY OF THE INVENTION

One object of the present invention is to provide a main body for a water-feeding device for domestic animals with low material and manufacturing costs.

In order to achieve the object of the present invention, the solid stainless steel lever is not used as the material of the main body; instead, it is replaced with thin stainless steel metal cylinder. For material with the same diameter and length, at least 70% of the material cost is saved. During the manufacturing process, a molding tool is used on a pressing machine and a thread rolling machine whether it is the cutting action of the material of the main body or the molding action of the shape or structure of each portion. The manufacturing process is efficient and saved the manufacturing time and cost.

In accordance with the water-feeding device for domestic animals, the water-feeding device for domestic animals, especially for chickens, includes a main body, a vertically weighted lever, a steel ball, a moving lever and a valve. When the main body is being molded during manufacturing, the pressing machine obtains a segment of thin stainless steel metal cylinder as the molding material using the pressing mold. Then, the upper half of the cylinder is narrowed to a cylinder with a narrow diameter and a small opening is formed at an upper end before a male thread is provided on the outer wall of the cylinder with a narrow diameter using the automatic thread rolling machine. The vertically weighted lever, the steel ball, the moving lever and the valve are inserted into the cylinder in sequence from bottom to top so as to allow the valve to be affixed at an edge between the cylinder with the narrower diameter at the upper half and the cylinder with the wider diameter and to pivotally plug the moving lever at the valve. Then, the cylinder with the originally bigger diameter at the lower end is narrowed to a narrower opening and formed with a sidewall of a hexagon. The water-feeding device for domestic animals, especially for chickens, is assembled.

Since the water-feeding device for domestic animals, especially for pigs, is bigger in size, it includes a main body, a steel ball, a valve and a moving lever. The molding step of the main body and the assembling step of the steel ball, the valve and the moving lever to form the water-feeding device for feeding pigs are the same as those of the water-feeding device for feeding chickens. However, since the diameter and the length of the moving lever for the water-feeding device for domestic animals, especially for pigs, is 2.5 times bigger than that for the water-feeding device for feeding chickens, the material cost is greatly increased; as a result, it is replaced with a segment of thin stainless steel metal cylinder as the molding material. The lever is then provided with a protruding ring in the middle thereof and a narrowed opening at the lower end so as to facilitate the affixation within the main body without getting loosened. When it is installed, the lower end of the moving lever will not hurt the mouth of the pig while drinking water.

### BRIEF DESCRIPTION OF THE DRAWINGS

FIG. 1 is a cross-sectional view of the water-feeding device for domestic animals, especially for chickens (amplified two times).

FIG. 2 is an exploded view of the water-feeding device for domestic animals, especially for chickens.

FIG. 3 is a schematic view of the molding steps of the water-feeding device for domestic animals, especially for chickens.

FIG. 4 is a cross-sectional view of the water-feeding device for domestic animals, especially for pigs (amplified two times).

FIG. 5 is a cross-sectional view of the conventional water-feeding device for domestic animals, especially for chickens.

FIG. 6 is an exploded view of the conventional water-feeding device for domestic animals, especially for chickens.

FIG. 7 is a cross-sectional view of the conventional water-feeding device for domestic animals, especially for pigs.

### DETAILED DESCRIPTION OF THE EMBODIMENTS

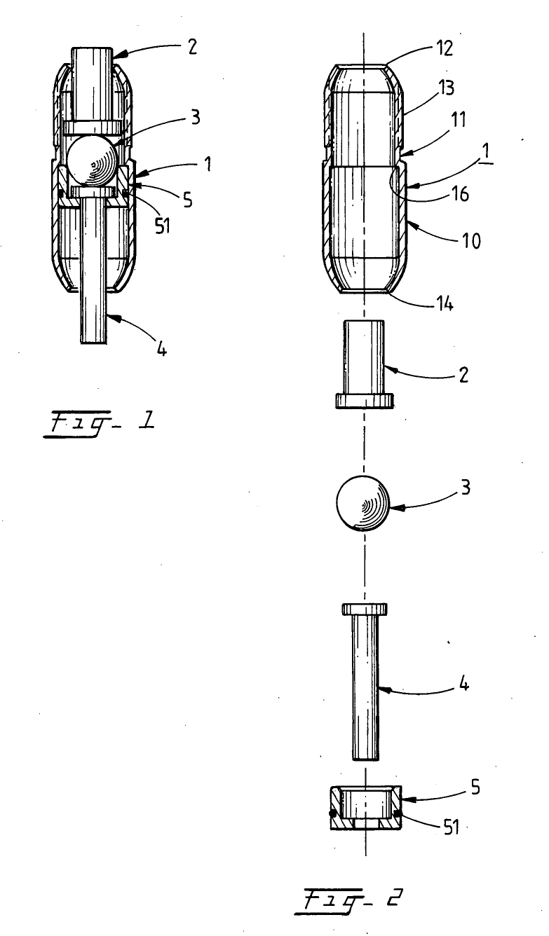

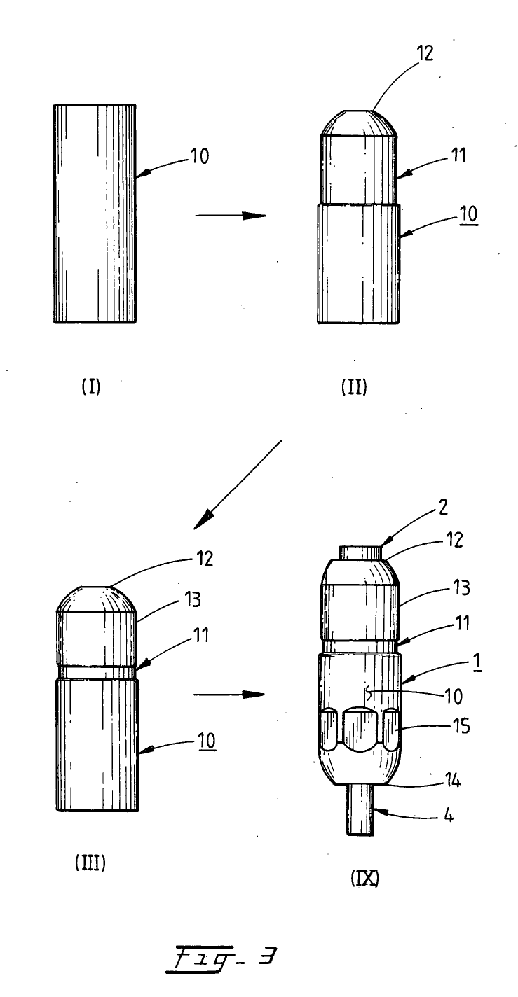

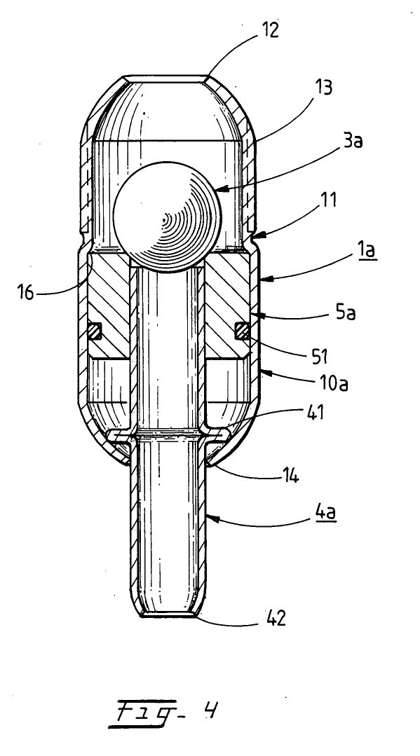

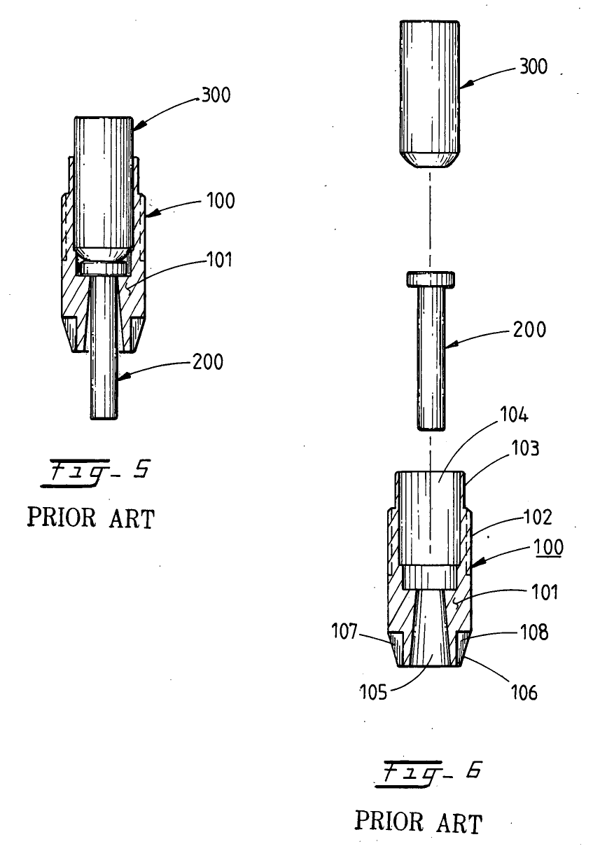

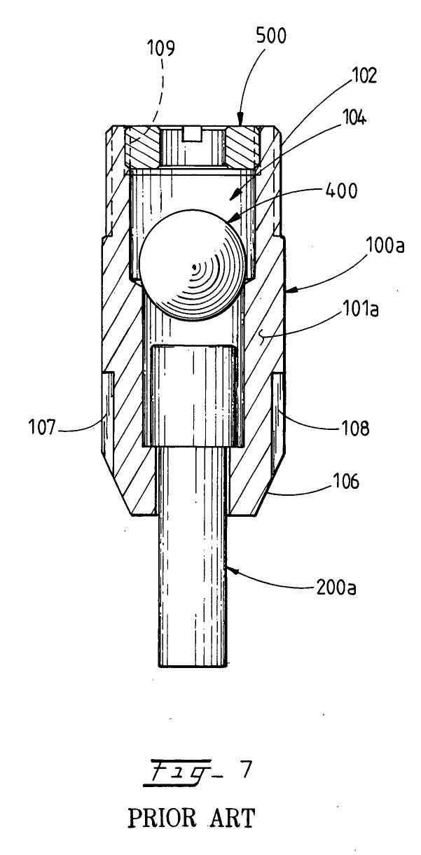

Refer to FIGS. 1 and 2, which illustrate the cross-sectional view amplified two times of the water-feeding device for domestic animals, especially for chickens, in accordance with the present invention and the exploded view thereof respectively. From these two figures, the water-feeding device for domestic animals, especially for chickens, in accordance with the present invention includes a main body 1, a vertically weighted lever 2, a steel ball 3, a moving lever 4 and a valve 5. Wherein, the vertically weighted lever 2, the moving lever 4 and the valve 5 are small components. Although they are made of stainless steel lever, the diameter is not big and can be manufactured in conjunction by an automatic lathe; as a result, there's no room to save material and manufacturing cost. The steel ball 3 and the rubber ring 51 on the valve 5 are cheap components available on the market and thus need not be changed. The present invention is focused on the material and the molding step of the main body 1 of the water-feeding device for domestic animals in accordance with the present invention for improvement. During manufacturing process, the material of the main body 1 for the lever is not solid stainless steel, and it is replaced with a thin stainless steel metal cylinder 10 as the material for the main body 1, as shown in FIG. 3(I). The manufacturing steps are shown as FIGS. 3(I), (II), (III) and (IX). The pressing machine obtains a segment of a thin stainless steel metal cylinder 10 as a molding material by using a pressing mold. Then, the pressing machine narrows the upper half of the cylinder 10 into a cylinder 11 with a narrower diameter, and the upper end of the cylinder is narrowed to a small opening 12 by using the pressing mold. A male thread 13 is provided around the outer sidewall of the cylinder 11 with the smaller diameter by using the automatic thread rolling machine, as shown in FIG. 3(III). Then, the vertically weighted lever 2, the steel ball 3, the moving lever 4 and the valve 5 are inserted into the cylinder 10 in sequence from bottom to top such that the valve 5 installed with at least one rubber ring 51 are affixed at the edge 16 between the cylinder 11 with the smaller diameter at the upper half and the cylinder 10 with the bigger diameter at the lower end, as shown in FIG. 2, and such that the moving lever 4 is pivotally inserted in the valve 5. Finally, the pressing machine narrows the lower end of cylinder 10 with the bigger diameter at the pressing mold to a smaller opening 14 and forms with a segment of sidewall of a hexagon 15 used for clamping a wrench for assembly or disassembly. The water-feeding device for domestic animals, especially for chickens, is thus assembled.

Refer to FIG. 4, which illustrates a cross-sectional view amplified two times of a water-feeding device for domestic animals, especially for pigs, in accordance with the present invention. The water-feeding device for domestic animals, especially for pigs, in accordance with the present invention includes a main body 1a, a steel ball 3a, a moving lever 4a and a valve 5a. The molding step using the stainless steel metal cylinder 10a as the material of the main body 1a and the assembling step assembling the steel ball 3a, the valve 5a and the moving lever 4a into the water-feeding device for feeding pigs are the same as that for feeding chicken, and thus are not described in detail hereinafter. However, the diameter and the length of the moving lever 4a are at least 2.5 times greater than those of water-feeding device for domestic animals, especially for chickens, and the material cost is greatly increased. Thus, the molding material is replaced with a thin stainless steel metal cylinder 10a. The pressing machine obtains and provides a lever with a protruding ring 41 in the middle thereof and a narrowed opening 42 at the lower end so as to facilitate the affixation within the main body 1a without getting loosen. When it is installed, the lower end of the moving lever 4a will not hurt the mouth of the pig while drinking water.

1. A water-feeding device for domestic animals, comprising a main body, a vertically weighted lever, a steel ball, a moving lever and a valve, wherein the molding step of said main body comprises:
obtaining a segment of a thin metal cylinder as material; and
narrowing an upper half of said cylinder with a smaller diameter and a small opening at an upper end; providing a male thread at a sidewall of said cylinder with said smaller diameter; then inserting said vertically weighted lever, said steel ball, said moving lever and said valve into said cylinder from bottom to top in sequence such that said valve is affixed at an edge between said cylinder with said smaller diameter and said metal cylinder with a bigger diameter on the lower portion thereof and such that said moving lever is pivotally inserted in said valve; then, pressing said cylinder with said bigger diameter at said lower end of said cylinder with a press mold to narrow to a small opening and formed with a sidewall of a hexagon so as to assemble into said water-feeding device for domestic animals.

2. The water-feeding device of claim 1, wherein said water-feeding device comprises a main body, a steel ball, a valve and a moving lever, and said moving lever comprises a lever using a segment of a thin metal cylinder as molding material and manufacturing with a protruding ring in the middle thereof and a small opening at said lower end.
